(19) United States
(12) Patent Application Publication
(10) Pub. No.: US 2025/0146740 A1
(43) Pub. Date: May 8, 2025

(54) ONBOARD REFRIGERATOR AND VEHICLE

(71) Applicant: BEIJING CHEHEJIA AUTOMOBILE TECHNOLOGY CO., LTD., Beijing (CN)

(72) Inventors: Ziwen ZHANG, Beijing (CN); Peng QIU, Beijing (CN); Meisui LIN, Beijing (CN)

(21) Appl. No.: 18/844,439

(22) PCT Filed: Mar. 7, 2023
(86) PCT No.: PCT/CN2023/080172

§ 371 Date: Sep. 6, 2024

(30) Foreign Application Priority Data
Mar. 9, 2022 (CN) 202220505946.3
Mar. 18, 2022 (CN) 202220608724.4

(51) Int. Cl. F25D 23/06; B60N 3/10

(52) U.S. Cl. CPC F25D 23/065; B60N 3/10

(57) ABSTRACT

An onboard refrigerator includes: a cabinet, a drawer, and a sliding component. The drawer is slidably provided inside the cabinet, the sliding component includes a first sliding member and a second sliding member, the first sliding member is provided on the drawer, the second sliding member is provided at an inner wall surface of the cabinet, the second sliding member has a sliding surface that is sliding-fitted to the first sliding member, and the sliding surface of the second sliding member and a plane orthogonal to a height direction of the cabinet have an included angle therebetween in a first direction, the first direction being orthogonal to the height direction and a front-rear direction of the cabinet.

### CROSS REFERENCE TO RELEVANT APPLICATIONS

The present application is a national stage entry under 35 U.S.C. § 371 of International Application No. PCT/CN2023/080172, filed on Mar. 7, 2023, which claims priority to Chinese Patent Application No. 202220505946.3, filed on Mar. 9, 2022, and Chinese Patent Application No. 202220608724.4, filed on Mar. 18, 2022, the entire disclosures of which are hereby incorporated herein by reference.

### TECHNICAL FIELD

The present disclosure relates to the technical field of refrigerating devices, and particularly to an onboard refrigerator and a vehicle.

### BACKGROUND

Onboard refrigerators, as one of the most commonly used home appliance products, serve for the routine work to preserve freshness of food for the users. In the related art, the sliding structure for connecting the drawer and the cabinet inside the onboard refrigerators occupies a large room inside the refrigerator, which restricts the capacity for the articles of the onboard refrigerators, and therefore the volume is low. Furthermore, the door plate of the onboard refrigerators is of a flip structure, and when the user requires taking or placing the articles inside the storage room, he is required to stretch his hand into the storage room.

### SUMMARY

The embodiments of the present disclosure provide an onboard refrigerator that facilitates the user to take or place articles, has a reasonable structural design, and has a large volume.

The embodiments of the present disclosure further provide a vehicle.

The onboard refrigerator according to the embodiments of the present disclosure includes:
a cabinet;
a drawer, wherein the drawer is slidably provided inside the cabinet; and
a sliding component, wherein the sliding component includes a first sliding member and a second sliding member, the first sliding member is provided on the drawer, the second sliding member is provided at an inner wall surface of the cabinet, the second sliding member has a sliding surface that is sliding-fitted to the first sliding member, and the sliding surface of the second sliding member and a plane orthogonal to a height direction of the cabinet have an included angle therebetween.

In some embodiments, the sliding component further includes a fixing base, the fixing base is provided inside the cabinet, the second sliding member is provided on the fixing base, the fixing base has an oblique surface, the oblique surface forms the included angle with the plane, the second sliding member is provided on the oblique surface, and the sliding surface of the second sliding member is parallel to the oblique surface.

In some embodiments, a quantity of the first sliding member is at least two, a quantity of the second sliding member is at least two, each of the first sliding members corresponds to one instance of the second sliding members, the oblique surface is a plurality of oblique surfaces, and each of the second sliding members corresponds to one instance of the plurality of oblique surfaces.

In some embodiments, the fixing base includes a first side surface and a second side surface that are provided opposite to each other in a first direction, the oblique surface includes the first side surface and the second side surface, the first direction is orthogonal to the height direction and a front-rear direction of the cabinet, the first side surface extends in a direction from bottom to top and inclines toward the second side surface, the second side surface extends in the direction from bottom to top and inclines toward the first side surface, one instance of the second sliding members corresponds to the first side surface, and another instance of the second sliding members corresponds to the second side surface.

In some embodiments, the included angle is greater than or equal to 30 degrees and less than or equal to 60 degrees.

In some embodiments, the second sliding member is detachably connected to the oblique surface.

In some embodiments, a first stopper is provided at a front end of the fixing base, a first fitting part is provided at a rear end of the drawer, and the first stopper is capable of fitting to the first fitting part to restrict a maximum opening degree of the drawer.

In some embodiments, a second stopper is provided at the front end of the fixing base, the second stopper includes an elastic member that is telescopic in the height direction of the cabinet, a second fitting part is provided at a bottom of the drawer, the second fitting part is located between a front end and the rear end of the drawer, and the second stopper is capable of fitting to the second fitting part to position the drawer.

In some embodiments, a quantity of the second stopper is at least two, and the first stopper is provided between neighboring instances of the second stoppers.

In some embodiments, the first stopper and the second stopper face each other and are separate in a first direction, wherein the first direction is orthogonal to the height direction and a front-rear direction of the cabinet.

In some embodiments, a rack is provided on one of the drawer and the fixing base, a damping gear is provided on the other of the drawer and the fixing base, and the damping gear and the rack are fitted.

In some embodiments, the onboard refrigerator further includes an installation frame, the installation frame is provided at a bottom wall of the drawer, the damping gear is provided on the installation frame, and the rack is provided on the fixing base and extends in a length direction of the second sliding member.

The vehicle according to another embodiment of the present disclosure includes: a vehicle body; and an onboard refrigerator, wherein the onboard refrigerator is provided inside the vehicle body, and the onboard refrigerator is the onboard refrigerator according to any one of the above embodiments.

### BRIEF DESCRIPTION OF THE DRAWINGS

FIG. 1 is a schematic diagram when the drawer of an onboard refrigerator according to an embodiment of the present disclosure has been drawn out.

FIG. 2 is a schematic structural diagram of a drawer according to an embodiment of the present disclosure.

FIG. 3 is a schematic diagram of cooperation of a door plate, a drawer and a sliding component of an onboard refrigerator according to an embodiment of the present disclosure.

FIG. 4 is a schematic diagram of cooperation between a first sliding member and a second sliding member of an onboard refrigerator according to an embodiment of the present disclosure.

FIG. 5 is an enlarged view of A in FIG. 4.

FIG. 6 is a schematic diagram of a fixing base of an onboard refrigerator according to an embodiment of the present disclosure.

FIG. 7 is a partially bottom view of a drawer of an onboard refrigerator according to an embodiment of the present disclosure.

FIG. 8 is a schematic structural diagram of a drawer and a fixing base of an onboard refrigerator according to an embodiment of the present disclosure.

Reference numbers:
1: cabinet;
2: drawer; 21: first fitting part; 22: second fitting part;
3: sliding component; 31: first sliding member; 32: second sliding member; 321: second installation sites; 33: fixing base; 331: first installation sites; 332: rack; 333: first stopper; 334: second stopper; 335: elastic piece; 336: first side surface; 337: second side surface; 34: connectors;
51: installation frame; 52: damping gear;
6: door plate;
7: housing; 71: first frame body; and 72: second frame body.

### DETAILED DESCRIPTION

The embodiments of the present disclosure will be described in detail below, and the examples of the embodiments are illustrated in the drawings. The embodiments described below with reference to the drawings are exemplary, are intended to interpret the present disclosure, and should not be construed as a limitation on the present disclosure.

In related art, the door plate of the onboard refrigerators is of a flip structure, and when the user requires taking or placing the articles inside the storage room, he is required to stretch his hand into the storage room. However, because the onboard refrigerator has a small size, and the articles are blocked by the cabinet, the user, when taking or placing the articles, has a poor visibility, and the operation is inconvenient.

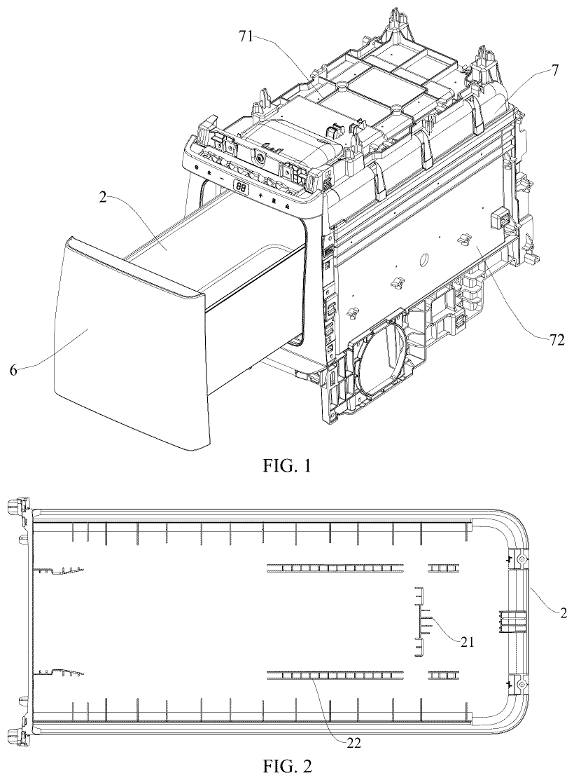

The onboard refrigerator and the vehicle according to the embodiments of the present disclosure will be described below with reference to FIG. 1 to FIG. 8.

As shown in FIG. 1 to FIG. 8, the onboard refrigerator according to an embodiment of the present disclosure includes a cabinet 1, a drawer 2 and a sliding component 3. The drawer 2 is slidably provided inside the cabinet 1. The sliding component 3 includes a first sliding member 31 and a second sliding member 32, the first sliding member 31 is provided on the drawer 2, the second sliding member 32 is provided at the inner wall surface of the cabinet 1, the second sliding member 31 has a sliding surface that is sliding-fitted to the first sliding member 31, and the sliding surface of the second sliding member 32 and a plane orthogonal to the height direction of the cabinet 1 have an included angle therebetween.

In other words, the first sliding member 31 and the second sliding member 32 are slidably connected, so that the drawer 2 is movable between an opening position and a closing position. When the drawer 2 is in the opening position, at least part of the drawer 2 is located outside the cabinet 1, whereby the user takes or places the articles inside the drawer 2. When the drawer 2 is in the closing position, the drawer 2 is located inside the cabinet 1.

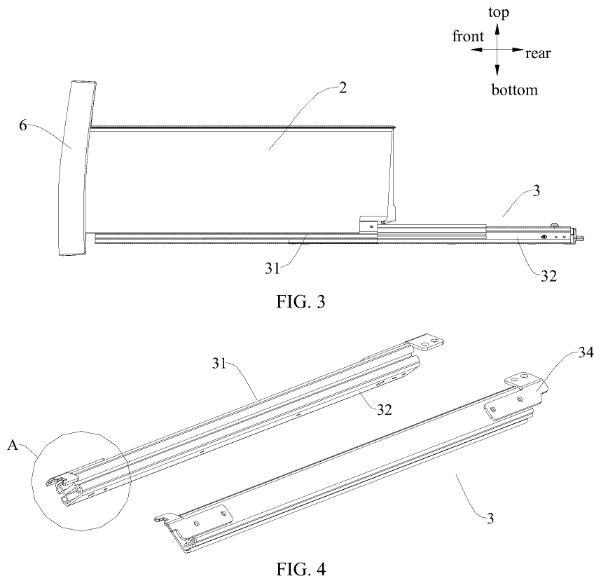

It can be understood that the first sliding member 31 and the drawer 2 are fixed to each other, the second sliding member 32 and the cabinet 1 are fixed to each other, and the first sliding member 31 is slidable in the length direction (for example, the front-rear direction in FIG. 3) of the second sliding member 32, whereby at least part of the drawer 2 can be drawn out of the cabinet 1 in the opening position, and the drawer 2 can be pushed into the cabinet 1 in the closing position.

In some embodiments, the included angle formed between the sliding surface of the second sliding member 32 and the plane orthogonal to the height direction of the cabinet 1 is greater than 0° and less than 90°.

In some other embodiments, the included angle formed between the sliding surface of the second sliding member 32 and the plane orthogonal to the height direction of the cabinet 1 is greater than 90° and less than 180°.

The sliding surface of the second sliding member 32 of the onboard refrigerator according to the embodiments of the present disclosure has a certain included angle with the plane orthogonal to the height direction of the cabinet 1; in other words, the sliding surface of the second sliding member 32 inclines. That can enable the second sliding member 32 to have a reduced dimension in the height direction of the cabinet 1, and accordingly reduces the dimension in the height direction of the cabinet 1 of the structure formed by the cooperation between the first sliding member 31 on the drawer 2 and the second sliding member 32, i.e., reducing the room inside the cabinet 1 that is occupied by the structure formed by the cooperation between the first sliding member 31 and the second sliding member 32. In an aspect, when the volume of the cabinet 1 is fixed, the volume of the drawer 2 can be increased, so as to store more articles. In another aspect, when the volume of the drawer 2 is fixed, the size of the outer contour of the cabinet 1 can be reduced, to reduce the room occupied by the onboard refrigerator.

In addition, by providing the movable drawer 2 inside the cabinet 1, that can facilitate the user to take out the articles inside the cabinet 1 and place the articles into the cabinet 1 with convenient operations. Furthermore, because the first sliding member 31 is provided on the drawer 2, the second sliding member 32 is provided inside the cabinet 1, and the first sliding member 31 and the second sliding member 32 are slidably connected, the drawer 2, when drawn, can have a good stability, and does not easily shake, to have a good effect of usage. In some embodiments, as shown in FIG. 6, the sliding component 3 further includes a fixing base 33, the sliding component 3 further includes a fixing base 33, the fixing base 33 is provided inside the cabinet 1, and the second sliding member 32 is provided on the fixing base 33.

For example, as shown in FIG. 6, the inner wall surface of the cabinet 1 includes a bottom wall, the fixing base 33 is provided on the bottom wall, and the second sliding member 32 is provided on the fixing base 33. It can be understood that the fixing base 33 and a storage room 11 are fixed to each other, and the fixing base 33 is provided at the bottom of the storage room 11, which can enable the drawer 2 to have a better stability when drawn.

The fixing base 33 has an oblique surface, the oblique surface forms the included angle with the plane, the second sliding member 32 is provided on the oblique surface, and the sliding surface of the second sliding member 32 is parallel to the oblique surface. The plane refers to the plane orthogonal to the height direction of the cabinet 1.

It can be understood that the oblique surface of the fixing base 33 can enable the second sliding member 32 provided thereon to incline; in other words, it can enable the sliding surface of the second sliding member 32 and the plane orthogonal to the height direction of the cabinet 1 to form an included angle therebetween, thereby, by utilizing the structure of the fixing base 33, enabling the sliding surface and the plane orthogonal to the height direction of the cabinet 1 to form the included angle therebetween, which improves the structural integrality of the onboard refrigerator.

In some embodiments, the quantity of the first sliding member 31 is at least two, the quantity of the second sliding member 32 is at least two, each of the first sliding members 31 corresponds to one second sliding member 32, the oblique surface is a plurality of oblique surfaces, and each of the second sliding members 32 corresponds to one oblique surface.

For example, as shown in FIG. 4, there are two first sliding members 31 and two second sliding members 32, wherein one of the two first sliding members 31 cooperates with one of the two second sliding members 32, and the other of the two first sliding members 31 cooperates with the other of the two second sliding members 32. It can be understood that, by connecting the drawer 2 and the cabinet 1 by using the plurality of first sliding members 31 and second sliding members 32, that does not only enable the connection between the drawer 2 and the cabinet 1 to be more stable, but also improves the stability of the drawer 2 in the sliding state.

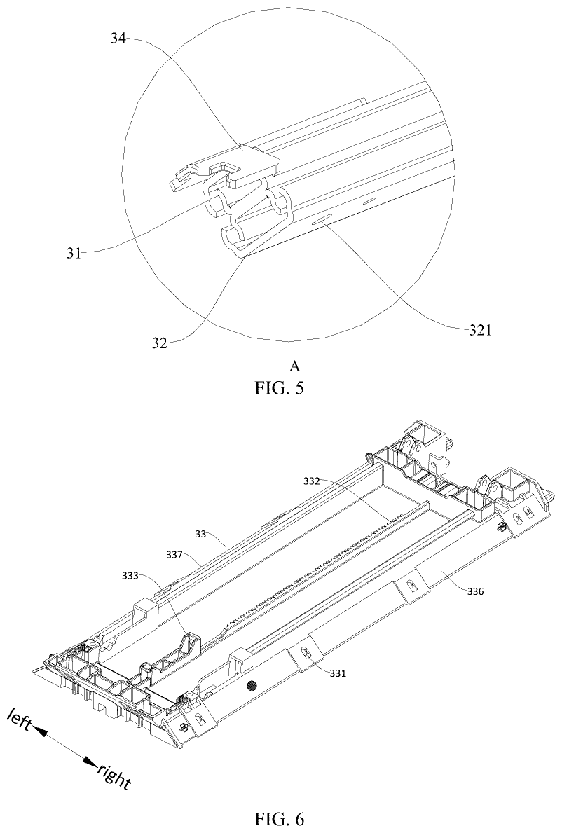

In some embodiments, as shown in FIG. 4 and FIG. 5, the sliding component 3 further includes connectors 34, the connectors 34 are at least two connectors, the two connectors 34 are provided at the two ends of the first sliding member 31, and the connectors 34 are detachably connected to the first sliding member 31 and the drawer 2. For example, each of the connectors 34 may be a metal-plate member, one end of the connector 34 is connected to the first sliding member 31 by a thread member, and the other end of the connector 34 is connected to the drawer 2 by a thread member, whereby the connection between the second sliding member 32 and the drawer 2 can have a simple structure, a high connection strength and a long service life.

In some embodiments, as shown in FIG. 6, the fixing base 33 includes a first side surface 336 and a second side surface 337 that are provided opposite to each other in a first direction (for example, the left-right direction shown in FIG. 3), the oblique surface includes the first side surface 336 and the second side surface 337, the first direction is orthogonal to the height direction and the front-rear direction of the cabinet, the first side surface 336 extends in the direction from bottom to top and inclines toward the second side surface 337, the second side surface 337 extends in the direction from bottom to top and inclines toward the first side surface 336, one second sliding member 32 corresponds to the first side surface 336, and another second sliding member 32 corresponds to the second side surface 337.

In other words, the spacing distance between the upper end of the first side surface 336 and the upper end of the second side surface 337 is greater than the spacing distance between the lower end of the first side surface 336 and the lower end of the second side surface 337.

In some embodiments, the first side surface 336 extends in the direction from bottom to top and inclines away from the second side surface 337, the second side surface 337 extends in the direction from bottom to top and inclines away from the first side surface 336, one second sliding member 32 corresponds to the first side surface 336, and another second sliding member 32 corresponds to the second side surface 337.

In other words, the spacing distance between the lower end of the first side surface 336 and the lower end of the second side surface 337 is greater than the spacing distance between the upper end of the first side surface 336 and the upper end of the second side surface 337.

It can be understood that both of the first side surface 336 and the second side surface 337 incline, to cause the second sliding member 32 provided on the first side surface 336 and the second side surface 337 to incline, and accordingly reduces the dimension in the height direction of the cabinet 1 of the structure formed by the cooperation between the first sliding member 31 on the drawer 2 and the second sliding member 32. In an aspect, when the volume of the cabinet 1 is unchanged, the volume of the drawer 2 can be increased, so as to store more articles. In another aspect, when the volume of the drawer 2 is unchanged, the size of the outer contour of the cabinet 1 can be reduced, to reduce the room occupied by the onboard refrigerator. Optionally, the included angle formed between the sliding surface of the second sliding member 32 and the plane orthogonal to the height direction of the cabinet 1 is greater than or equal to 30 degrees and less than or equal to 60 degrees.

It can be understood that, when the included angle is greater than or equal to 30 degrees and less than or equal to 60 degrees, in an aspect, that can reduce the dimension in the height direction of the cabinet 1 of the structure formed by the cooperation between the first sliding member 31 and the second sliding member 32, thereby reducing the volume that is occupied by the structure formed by the cooperation between the first sliding member 31 and the second sliding member 32. In another aspect, the large included angle can prevent damaging the second sliding member 32 by an excessively large gravity of the drawer 2.

In some embodiments, as shown in FIG. 6, the fixing base 33 and the bottom wall are detachably connected. For example, the fixing base 33 may be connected to the bottom wall by a thread member, a snap-fitting structure and so on, which facilitates the processing and the manufacturing of the onboard refrigerator and facilitate the assembling.

In some embodiments, as shown in FIG. 4 to FIG. 6, the fixing base 33 and the second sliding member 32 are detachably connected. For example, the fixing base 33 is provided with a plurality of first installation sites 331 that are separate in the length direction of the fixing base 33, the second sliding member 32 is provided with a plurality of second installation sites 321 that are separate in the length direction of the second sliding member 32, the plurality of first installation sites 331 and the plurality of first installation sites 331 correspond one to one, the sliding component 3 further includes thread members, and the thread members are connected to the first installation sites 331 and the second installation sites 321. It can be understood that the fixing base 33 and the second sliding member 32 are fixed by using the plurality of thread members, which can improve the stability of the connection between the fixing base 33 and the second sliding member 32, and has a simple structure and a convenient assembling.

In some embodiments, as shown in FIG. 2 and FIG. 8, a first stopper 333 is provided at the front end of the fixing base 33, a first fitting part 21 is provided at the rear end of the drawer 2, and the first stopper 333 is capable of fitting to the first fitting part 21 to restrict the maximum opening degree of the drawer 2. In other words, when the drawer 2 is in the position of the maximum opening degree, the first stopper 333 may cooperate with the first fitting part 21, to cause the drawer 2 to be unable to continue to move out of the cabinet 1, to ensure that the drawer 2 does not fall out of the cabinet 1. That can prevent, in harsh operation conditions, for example, when the vehicle is travelling in a road having poor road conditions, intensive vibration of the vehicle and falling of the drawer 2 out of the cabinet 1, which improves the usage experience of the user.

In some embodiments, as shown in FIG. 2 and FIG. 8, a second stopper 334 is provided at the front end of the fixing base 33, the second stopper 334 includes an elastic member 335 that is telescopic in the height direction of the cabinet 1, a second fitting part 22 is provided at the bottom of the drawer 2, the second fitting part 22 is located between the front end and the rear end of the drawer 2, and the second stopper 334 is capable of fitting to the second fitting part 22 to position the drawer 2.

For example, as shown in FIG. 8, one end of the second stopper 334 is pivotably connected to the fixing base 33, the other end of the second stopper 334 is connected to or contacts one end of the elastic member 335, and the other end of the elastic member 335 is connected to or contacts the fixing base 33.

When the drawer 2 has been pulled out by a certain distance, the end of the second stopper 334 that is connected to or contacts the elastic member 335 may abut the second fitting part 22, which restricts the movement of the drawer 2, to cause the second stopper 334 to serve to position the drawer 2. Continuing to pull the drawer 2 causes the second stopper 334 to bear a larger force of the second fitting part 22, and the second fitting part 22 presses the second stopper 334 downwardly, which reduces the height of the end of the second stopper 334 that serves for limiting, whereby the second stopper 334 cannot limit the second fitting part 22, to enable the drawer 2 to continue to move out of the cabinet 1. It can be understood that the degree with which the drawer 2 can be drawn out is controlled by using the cooperation between the second stopper 334 and the second fitting part 22, which improves the usage experience of the user.

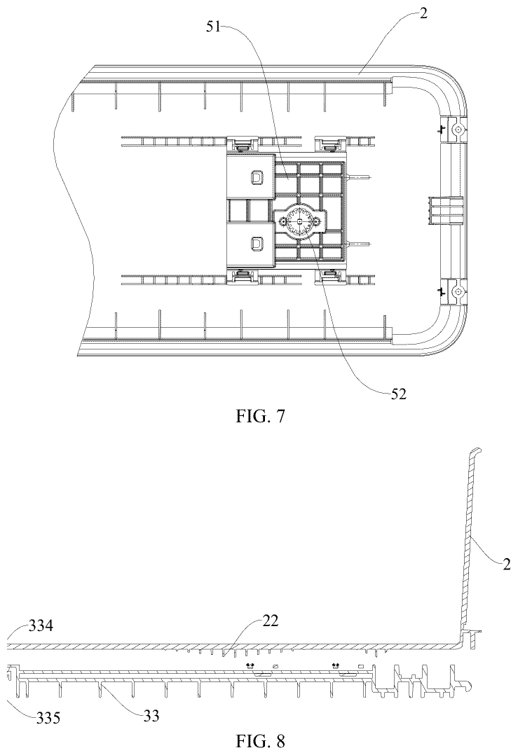

In some embodiments, as shown in FIG. 6 and FIG. 7, a rack 332 is provided on one of the drawer 2 and the fixing base 33, a damping gear 52 is provided on the other of the drawer 2 and the fixing base 33, and the damping gear 52 and the rack 332 are fitted. For example, the rack 332 is provided on the fixing base 33, and the rack 332 is located in the middle position of the fixing base 33 and extends in a length direction of the second sliding member 32 (for example, the front-rear direction in FIG. 3). The damping gear 52 is provided on the drawer 2. In the onboard refrigerator according to the embodiments of the present disclosure, by providing the rack 332 and the damping gear 52, the drawer 2 can have a damping sense when drawn, whereby the drawer 2, when drawn, has a good effect, thereby improving the usage experience of the user.

In some embodiments, as shown in FIG. 7, the onboard refrigerator further includes an installation frame 51, the installation frame 51 is provided at the bottom wall of the drawer 2, and the damping gear is provided on the installation frame 51. For example, the installation frame 51 is snap-fitted to the bottom of the drawer 2, which can prevent perforating the drawer 2, and facilitates the installation. The installation frame 51 may be connected to the damping gear 52 by a thread member, and the damping gear 52 is rotatable relative to the installation frame 51. In the onboard refrigerator according to the embodiments of the present disclosure, by the above configuration, the operator can replace the component parts such as the damping gear 52, to have a good effect of usage.

In some embodiments, as shown in FIG. 5, one of the first sliding member 31 and the second sliding member 32 is provided with a sliding rail, the other is provided with a guide groove, and the sliding rail is sliding-fitted inside the guide groove. For example, the first sliding member 31 is provided with the sliding rail, the second sliding member 32 is provided with the guide groove, and the lower end of the sliding rail is embedded into the guide groove, and is slidable in the length direction of the guide groove. That can prevent derailment between the first sliding member 31 and the second sliding member 32, to enable the drawer 2 to have a high reliability in usage.

In some embodiments, as shown in FIG. 1 and FIG. 2, the onboard refrigerator further includes a door plate 6, the door plate 6 is connected to the drawer 2, and, in the closing position, the door plate 6 closes the cabinet 1. In some embodiments, the drawer 2 and the door plate 6 are detachably connected. For example, the drawer 2 is connected to the door plate 6 by a thread member or a snap-fitting structure, which facilitates the processing and manufacturing and simplifies the assembling. Alternatively, the drawer 2 and the door plate 6 are integrally formed, which can increase the structural strength and prolong the service life.

In some embodiments, as shown in FIG. 1, the refrigerator further includes a housing 7, an installation cavity is provided inside the housing 7, and the cabinet 1 is provided inside the installation cavity. The housing 7 may be an injection-molded member, which can reduce the weight of the refrigerator, and can ensure the structural strength of the refrigerator. For example, the housing 7 includes a first frame body 71 and a second frame body 72, and the first frame body 71 is provided at the upper end of the second frame body 72 to enclose the installation cavity. Both of the first frame body 71 and the second frame body 72 are an injection-molded member, and the first frame body 71 and the second frame body 72 are connected by a thread member. In the refrigerator according to the embodiments of the present disclosure, by configuring the housing 7 to be the first frame body 71 and the second frame body 72, the quantity of the component parts for assembling the housing 7 can be reduced, and the light-weighting design enables the refrigerator to have a low weight.

The vehicle according to another embodiment of the present disclosure includes a vehicle body and an onboard refrigerator, wherein the onboard refrigerator is provided inside the vehicle body, and the onboard refrigerator is the onboard refrigerator according to the embodiments of the present disclosure.

In the vehicle according to the embodiments of the present disclosure, the sliding surface of the second sliding member 32 of the onboard refrigerator has a certain included angle with the plane orthogonal to the height direction of the cabinet 1, which reduces the room inside the cabinet 1 that is occupied by the structure formed by the cooperation between the first sliding member 31 and the second sliding member 32, and therefore the drawer 2 can have a larger room for storing more articles. In addition, by providing the movable drawer 2 inside the cabinet 1, that can facilitate the user to take out the articles inside the cabinet 1 and place the articles into the cabinet 1 with convenient operations.

In the description of the present disclosure, it should be understood that the terms that indicate orientation or position relations, such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial” and “circumferential”, are based on the orientation or position relations shown in the drawings, and are merely for conveniently describing the present disclosure and simplifying the description, rather than indicating or implying that the device or element must have the specific orientation and be constructed and operated according to the specific orientation. Therefore, they should not be construed as a limitation on the present disclosure.

Moreover, the terms “first” and “second” are merely for the purpose of describing, and should not be construed as indicating or implying the degrees of importance or implicitly indicating the quantity of the specified technical features. Accordingly, the features defined by “first” and “second” may explicitly or implicitly include at least one of the features. In the description of the present disclosure, the meaning of “plurality of” is “at least two”, for example, two, three and so on, unless explicitly and particularly defined otherwise.

In the present disclosure, unless explicitly defined or limited otherwise, the terms “mount”, “connect”, “link” and “fix” should be interpreted broadly. For example, it may be fixed connection, detachable connection, or integral connection; it may be mechanical connection, electrical connection or mutual communication; and it may be direct connection or indirect connection by an intermediate medium, and may be internal communication between two elements or interaction between two elements, unless explicitly defined otherwise. For a person skilled in the art, the particular meanings of the above terms in the present disclosure may be comprehended according to particular situations.

In the present disclosure, unless explicitly defined or limited otherwise, that a first feature is “over” or “under” a second feature may include that the first feature and the second feature directly contact or that the first feature and the second feature indirectly contact via an intermediate medium. Furthermore, that a first feature is “above” a second feature may include that the first feature is directly over or obliquely over the second feature, or merely indicates that the vertical height of the first feature is greater than that of the second feature. That a first feature is “below” a second feature may include that the first feature is directly under or obliquely under the second feature, or merely indicates that the vertical height of the first feature is less than that of the second feature.

In the present disclosure, the terms “an embodiment”, “some embodiments”, “example”, “particular example” or “some examples” and so on mean that particular features, structures, materials or characteristics described with reference to the embodiment or example are included in at least one of the embodiments or examples of the present disclosure. In the description, the illustrative expressions of the above terms do not necessarily relate to the same embodiment or example. Furthermore, the described particular features, structures, materials or characteristics may be combined in one or more embodiments or examples in a suitable form. Moreover, subject to avoiding contradiction, a person skilled in the art may combine different embodiments or examples described in the description and the features of the different embodiments or examples.

Although the above embodiments have already been illustrated and described, it can be understood that the above embodiments are illustrative, and should not be construed as a limitation on the present disclosure, and all of the variations, modifications, substitutions and alterations made to the above embodiments by a person skilled in the art fall within the protection scope of the present disclosure.

1. An onboard refrigerator, wherein the onboard refrigerator comprises:
a cabinet;
a drawer, wherein the drawer is slidably provided inside the cabinet; and
a sliding component, wherein the sliding component comprises a first sliding member and a second sliding member, the first sliding member is provided on the drawer, the second sliding member is provided at an inner wall surface of the cabinet, the second sliding member has a sliding surface that is sliding-fitted to the first sliding member, and the sliding surface of the second sliding member and a plane orthogonal to a height direction of the cabinet have an included angle therebetween in a first direction, wherein the first direction is orthogonal to the height direction and a front-rear direction of the cabinet.

2. The onboard refrigerator according to claim 1, wherein the sliding component further comprises a fixing base, the fixing base is provided inside the cabinet, the second sliding member is provided on the fixing base, the fixing base has an oblique surface, the oblique surface forms the included angle with the plane, the second sliding member is provided on the oblique surface, and the sliding surface of the second sliding member is parallel to the oblique surface.

3. The onboard refrigerator according to claim 2, wherein a quantity of first sliding members is at least two, a quantity of second sliding members is at least two, each of the first sliding members corresponds to one instance of the second sliding members, the oblique surface is a plurality of oblique surfaces, and each of the second sliding members corresponds to one instance of the plurality of oblique surfaces.

4. The onboard refrigerator according to claim 3, wherein the fixing base comprises a first side surface and a second side surface that are provided opposite to each other in the first direction, the oblique surface comprises the first side surface and the second side surface, the first side surface extends in a direction from bottom to top and inclines toward the second side surface, the second side surface extends in the direction from bottom to top and inclines toward the first side surface, one instance of the second sliding members corresponds to the first side surface, and another instance of the second sliding members corresponds to the second side surface.

5. The onboard refrigerator according to claim 1, wherein the included angle is greater than or equal to 30 degrees and less than or equal to 60 degrees.

6. The onboard refrigerator according to claim 2, wherein the second sliding member is detachably connected to the oblique surface.

7. The onboard refrigerator according to claim 2, wherein a first stopper is provided at a front end of the fixing base, a first fitting part is provided at a rear end of the drawer, and the first stopper is capable of fitting to the first fitting part to restrict a maximum opening degree of the drawer.

8. The onboard refrigerator according to claim 7, wherein a second stopper is provided at the front end of the fixing base, the second stopper comprises an elastic member that is telescopic in the height direction of the cabinet, a second fitting part is provided at a bottom of the drawer, the second fitting part is located between a front end and the rear end of the drawer, and the second stopper is capable of fitting to the second fitting part to position the drawer.

9. The onboard refrigerator according to claim 8, wherein a quantity of the second stopper is at least two, and the first stopper is provided between neighboring instances of second stoppers.

10. The onboard refrigerator according to claim 8, wherein the first stopper and the second stopper face each other and are separate in the first direction, wherein the first direction is orthogonal to the height direction and the front-rear direction of the cabinet.

11. The onboard refrigerator according to claim 2, wherein a rack is provided on one of the drawer and the fixing base, a damping gear is provided on the other of the drawer and the fixing base, and the damping gear and the rack are fitted.

12. The onboard refrigerator according to claim 11, wherein the onboard refrigerator further comprises an installation frame, the installation frame is provided at a bottom wall of the drawer, the damping gear is provided on the installation frame, and the rack is provided on the fixing base and extends in a length direction of the second sliding member.

13. A vehicle, comprising:
a vehicle body; and
the onboard refrigerator according to claim 1, wherein the onboard refrigerator is provided inside the vehicle body.

14. The onboard refrigerator according to claim 1, wherein the first sliding member and the drawer are fixed to each other, the second sliding member and the cabinet are fixed to each other, and the first sliding member is slidable in a length direction of the second sliding member.

15. The onboard refrigerator according to claim 2, wherein the inner wall surface of the cabinet comprises a bottom wall, the fixing base is provided on the bottom wall, and the second sliding member is provided on the fixing base.

16. The onboard refrigerator according to claim 1, wherein the sliding component further comprises connectors, the connectors are at least two connectors, the at least two connectors are provided at two ends of the first sliding member, and the connectors are detachably connected to the first sliding member and the drawer.

17. The onboard refrigerator according to claim 16, wherein each of the connectors is a metal-plate member, one end of each connector is connected to the first sliding member by a thread member, and the other end of each connector is connected to the drawer by a thread member.

18. The onboard refrigerator according to claim 6, wherein the fixing base is provided with a plurality of first installation sites that are separate in a length direction of the fixing base, the second sliding member is provided with a plurality of second installation sites that are separate in a length direction of the second sliding member, and the plurality of first installation sites and the plurality of first installation sites correspond one to one; and
the sliding component further comprises thread members, and the thread members are connected to the plurality of first installation sites and the plurality of second installation sites.

19. The onboard refrigerator according to claim 8, wherein one end of the second stopper is pivotably connected to the fixing base, the other end of the second stopper is connected to or contacts one end of the elastic member, and the other end of the elastic member is connected to or contacts the fixing base.

20. The onboard refrigerator according to claim 1, wherein one of the first sliding member and the second sliding member is provided with a sliding rail, the other of the first sliding member and the second sliding member is provided with a guide groove, and the sliding rail is sliding-fitted inside the guide groove.
